(19) United States
(12) Patent Application Publication
(10) Pub. No.: US 2026/0134228 A1
(43) Pub. Date: May 14, 2026

(54) TRAINING METHOD FOR ARTIFICIAL INTELLIGENCE COMMUNICATION TOOL AND ELECTRONIC DEVICE

(71) Applicant: PEGATRON CORPORATION, TAIPEI CITY (TW)

(72) Inventor: Adrian Cheng, Taipei City (TW)

(73) Assignee: PEGATRON CORPORATION, TAIPEI CITY (TW)

(21) Appl. No.: 19/305,144

(22) Filed: Aug. 20, 2025

(30) Foreign Application Priority Data
Nov. 8, 2024 (TW) 113142878

(51) Int. Cl. G06F 40/40; G06F 18/2415

(52) U.S. Cl. CPC G06F 40/40; G06F 18/2415

(57) ABSTRACT

Disclosed are a training method for artificial intelligence (AI) communication tools and an electronic device. The training method includes: providing a communication result by the AI communication tool and receiving a correction prompt corresponding to the communication result; generating at least one answer based on the correction prompt by a prompt analysis model, and generating at least one similarity between the correction prompt and the at least one answer based on the at least one answer; and selecting an optimized answer from the at least one answer based on the at least one similarity by the prompt analysis model, correcting the communication result based on the optimized answer to generate a corrected communication result, and providing the corrected communication result to the AI communication tool.

### CROSS-REFERENCE TO RELATED APPLICATION

This application claims the priority benefit of Taiwan application serial no. 113142878, filed on November 8, 2024. The entirety of the above-mentioned patent application is hereby incorporated by reference herein and made a part of this specification.

### BACKGROUND

### Technical Field

The present disclosure relates to a training method and an electronic device, and particularly relates to a training method for an artificial intelligence (AI) communication tool and an electronic device.

### Description of Related Art

Generally speaking, for responses automatically generated by an artificial intelligence (AI) feedback system, users may select one or more dissatisfaction options with the responses, or provide additional feedback corresponding to the responses. However, the feedback formats provided by AI feedback systems are typically overly simple, and the formats of additional feedback that users may provide are excessively limited.

In order for an AI feedback system to generate ideal responses, a large quantity of response samples is typically required. Since deliberate response samples require substantial time to produce, most users lack the willingness to provide response samples. Generally speaking, users are more inclined to provide suggestions corresponding to responses through the selection of checkboxes. However, the checkbox method fails to fully express user’s feedback, and development teams find it difficult to construct complete response samples based solely on the checkboxes selected by users.

### SUMMARY

The present disclosure provides an electronic device and a training method for an artificial intelligence (AI) communication tool, which may more quickly provide users with ideal communication results.

In an embodiment of the present disclosure, a training method is provided for AI communication tools. The AI communication tool is installed in a computer system, and the computer system includes a processor. The processor is configured to execute the training method. The training method includes: by the AI communication tool, providing a communication result and receiving a correction prompt corresponding to the communication result; by a prompt analysis model, generating at least one answer based on the correction prompt and generating at least one similarity between the correction prompt and the at least one answer based on the at least one answer; and by the prompt analysis model, selecting an optimized answer from the at least one answer based on the at least one similarity, correcting the communication result based on the optimized answer to generate a corrected communication result, and providing the corrected communication result to the AI communication tool.

In an embodiment of the present disclosure, the electronic device includes an operation interface and a processor. The processor is coupled to the operation interface. The processor includes the AI communication tool and the prompt analysis model. The processor is operated based on the above training method.

Based on the above, the prompt analysis model automatically generates at least one answer according to the correction prompt. The at least one answer involves different response samples used to train the AI communication tool. In this way, users do not need to spend so much time formulating multiple response samples. The training method may obtain a large amount of response samples. In addition, the prompt analysis model selects an optimized answer from the at least one answer and corrects the communication result according to the optimized answer to generate a corrected communication result. The training method may also generate a corrected communication result that is the closest to the correction prompt.

### BRIEF DESCRIPTION OF THE DRAWINGS

FIG. 1 illustrates a schematic view of an electronic device according to an embodiment of the present disclosure.

FIG. 2 illustrates a flowchart of a training method according to an embodiment of the present disclosure.

FIG. 3A and FIG. 3B illustrate flowcharts of a training method according to an embodiment of the present disclosure.

FIG. 4 illustrates a flowchart of a training method according to an embodiment of the present disclosure.

FIG. 5 illustrates a schematic view of an operation interface according to an embodiment of the present disclosure.

FIG. 6 illustrates a block diagram according to an embodiment of the present disclosure.

### DESCRIPTION OF THE EMBODIMENTS

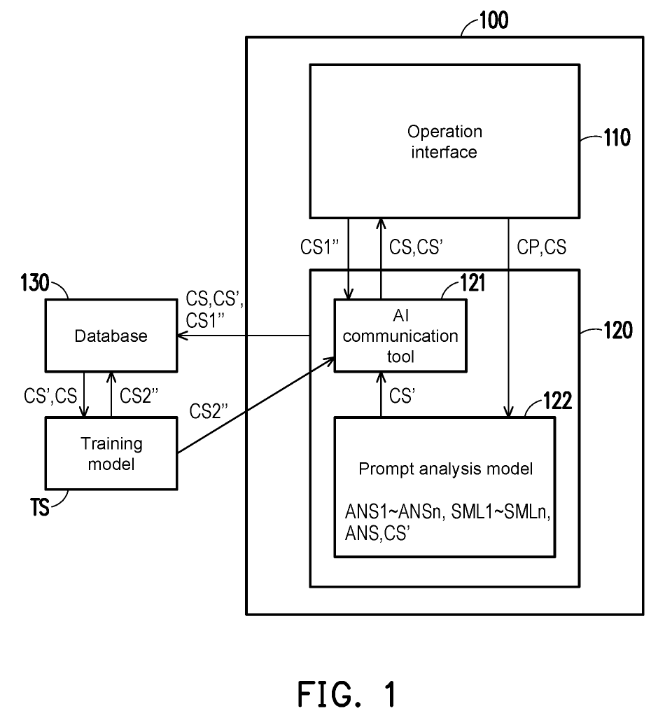

Please refer to FIG. 1, FIG. 1 illustrates a schematic view of an electronic device according to an embodiment of the present disclosure. In this embodiment, the electronic device 100 includes an operation interface 110 and a processor 120. The processor 120 is configured to execute an artificial intelligence (AI) communication tool 121 and a prompt analysis model 122. The AI communication tool 121 and the prompt analysis model 122 may be implemented through one of computing circuits or any combination thereof, and this disclosure does not limit the implementation methods of the AI communication tool 121 and the prompt analysis model 122.

When in use, the AI communication tool 121 may output a corresponding communication result CS according to data and questions provided by the user. For example, the "question" is, for example, a question regarding data content or a question regarding definitions of technical terms, etc. The AI communication tool 121 takes into consideration the data and the content of the question, and outputs the communication result CS that is logical and exclude erroneous information as much as possible. For example, when the user's question is about the definition of a technical term (for example, what is a green partner), since the question does not directly provide relevant information of the technical term, the communication result CS output by the AI communication tool 121 may be different from the output expected by the user, or the explanation of the technical term includes erroneous information. When the user is not satisfied with the communication result CS, the user may provide a correction prompt CP corresponding to the communication result CS.

In this embodiment, the prompt analysis model 122 receives the correction prompt CP provided by the user and generates answers ANS1~ANSn according to the correction prompt CP, and generates similarities SML1~SMLn between the correction prompt CP and the answers ANS1~ANSn. The prompt analysis model 122 selects an optimized answer ANS according to the similarities SML1~SMLn. For example, the prompt analysis model 122 compares the correction prompt CP with the answer ANS1 to generate the similarity SML1. The prompt analysis model 122 compares the correction prompt CP with the answer ANS2 to generate the similarity SML2, and so on.

Taking the answer ANS1 as an example, the prompt analysis model 122 retrieves at least one first message from the answer ANS1 and retrieves at least one second message from the correction prompt CP. The prompt analysis model 122 generates the similarity SML1 corresponding to the answer ANS1 according to at least one of a text similarity, a factual relationship, and a contradictory relationship between the at least one first message and the at least one second message.

In this embodiment, the prompt analysis model 122 selects the optimized answer ANS from the answers ANS1~ANSn according to the extent of the similarities SML1~SMLn. In addition, the prompt analysis model 122 corrects the communication result CS according to the optimized answer ANS to generate a corrected communication result CS'. Furthermore, the prompt analysis model 122 provides the corrected communication result CS' to the AI communication tool 121.

In this embodiment, the AI communication tool 121 may submit the communication result CS and the corrected communication result CS' to a database 130 as training data for subsequent training. In addition, the user may edit the corrected communication result CS' to generate and submit the edited corrected communication result CS1'' to the operation interface 110. The operation interface 110 may submit at least one of the communication result CS and the edited corrected communication result CS1'' to the database 130 as training data for subsequent training.

In this embodiment, the processor 120 is, for example, a Central Processing Unit (CPU), or other programmable general-purpose or special-purpose microprocessor, a Digital Signal Processor (DSP), a programmable controller, an Application Specific Integrated Circuit (ASIC), a Programmable Logic Device (PLD) or other similar device or combinations of these devices.

In this embodiment, the AI communication tool 121 and the prompt analysis model 122 are deep learning models such as a Convolutional Neural Network (CNN) and a Recurrent Neural Network (RNN), respectively, but the present disclosure is not limited thereto.

In this embodiment, the electronic device 100 may be a smartphone, a tablet computer, a laptop computer, a personal computer or a portable electronic device, but the present disclosure is not limited thereto.

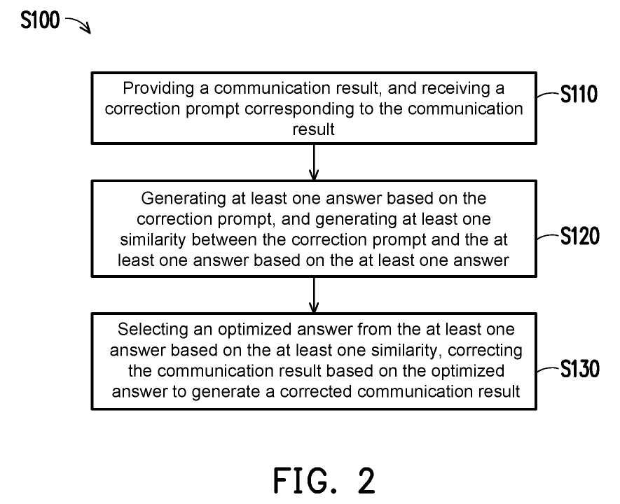

Please refer to FIG. 1 and FIG. 2, FIG. 2 illustrates a flowchart of a training method according to an embodiment of the present disclosure. In this embodiment, a training method S100 may be applicable to the electronic device 100. The training method S100 includes steps S110~S130. In step S110, the AI communication tool 121 provides the communication result CS corresponding to a question inputted by a user. In step S110, when the user is not satisfied with the communication result CS, the user may input the correction prompt CP corresponding to the communication result CS through the operation interface 110. The correction prompt CP is, for example, to correct specific content in the communication result CS, or to correct the definition of a technical term in the communication result CS.

In step S120, the prompt analysis model 122 generates the answers ANS1~ANSn according to the correction prompt CP and generates the similarities SML1~SMLn between the correction prompt CP and the answers ANS1~ANSn. The answers ANS1~ANSn are, for example, generated by a Large Language Model (LLM), and the answers ANS1~ANSn may include information that does not match actual conditions or content that does not conform to common sense. The prompt analysis model 122 may compare the content of the correction prompt CP with the answers ANS1~ANSn, thereby acquiring the extent of similarity between the answers ANS1~ANSn and the correction prompt CP to generate the corresponding similarities SML1~SMLn.

In step S130, the prompt analysis model 122 selects the optimized answer ANS from the answers ANS1~ANSn according to the similarities SML1~SMLn and corrects the communication result CS according to the optimized answer ANS to generate the corrected communication result CS'.

In this embodiment, the similarities SML1~SMLn are, for example, represented by numerical values. The similarities SML1~SMLn represent the extent of semantic proximity between the answers ANS1~ANSn and the correction prompt CP as well as the extent of content similarity between the answers ANS1~ANSn and the established facts. The extent of semantic proximity is, for example, a semantic distance between different texts that is measured based on cosine similarity. For example, different words with a small semantic gap have a close semantic distance. Different words with a large semantic gap have a farther semantic distance. For example, the smaller the difference between the answer ANS1 and the correction prompt CP is, the higher the numerical value of the similarity SML1 is. The larger the difference between the answer ANS1 and the correction prompt CP is, the lower the numerical value of the similarity SML1 is. Therefore, the prompt analysis model 122 selects the optimized answer ANS from the answers ANS1~ANSn according to the extent of the similarities SML1~SMLn. Furthermore, the prompt analysis model 122 corrects the communication result CS according to the optimized answer ANS to generate the corrected communication result CS'. In this embodiment, the optimized answer ANS is the answer corresponding to the highest similarity (i.e., the highest score). Therefore, the corrected communication result CS' is the result closest to the correction prompt CP generated by the prompt analysis model 122.

It is worth mentioning here that the prompt analysis model 122 automatically generates the answers ANS1~ANSn according to the correction prompt CP. The answers ANS1~ANSn may be utilized as response samples for training the AI communication tool 121. In this way, the user does not need to spend so much time to submit multiple response samples. The training method S100 may obtain a large amount of response samples. Furthermore, the prompt analysis model 122 selects the optimized answer ANS from the answers ANS1~ANSn and corrects the communication result CS according to the optimized answer ANS to generate the corrected communication result CS'. The training method may also generate the corrected communication result CS' that is the closest to the correction prompt CP.

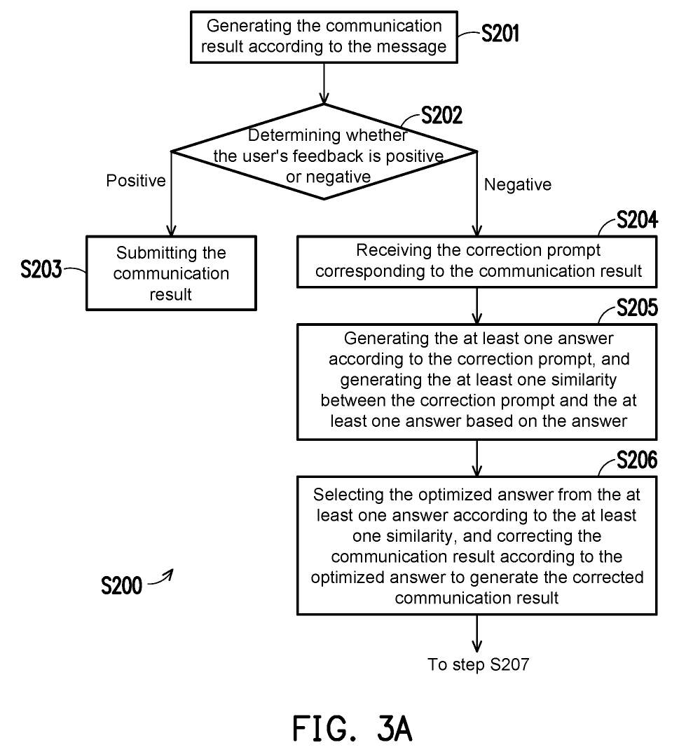

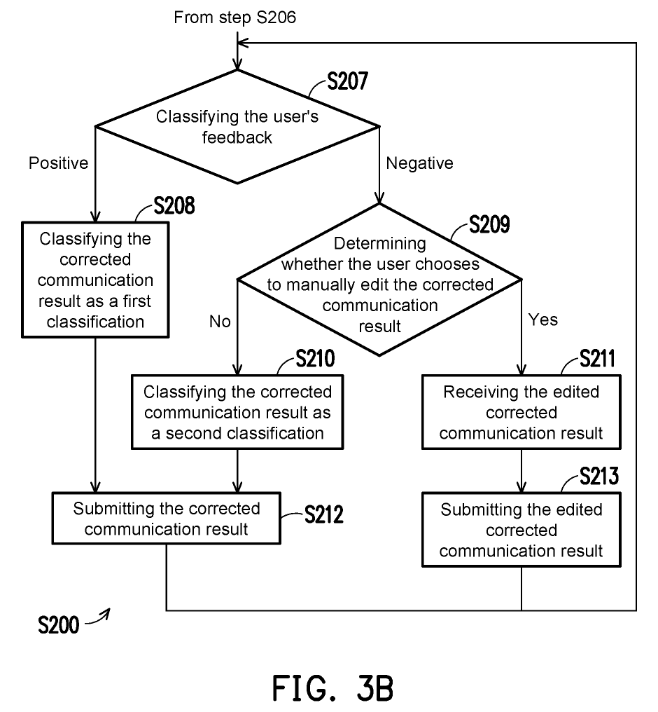

Please refer to FIG. 1, FIG. 3A and FIG. 3B. FIG. 3A and FIG. 3B illustrate flowcharts of a training method according to an embodiment of the present disclosure. In this embodiment, a training method S200 is applicable to the electronic device 100. The training method S200 includes steps S201~S213. In step S201, the user inputs a message on the operation interface 110, and the AI communication tool 121 generates the communication result CS according to the message.

In step S202, the AI communication tool 121 receives feedback from the user. When the feedback is positive, it means that the user is satisfied with the communication result CS generated by the AI communication tool 121. That is to say, the communication result CS generated by the AI communication tool 121 is accurate. Therefore, the AI communication tool 121 submits the message and the communication result CS that satisfies the user to the database 130 in step S203.

When the feedback is negative, it means that the user is not satisfied with the communication result CS, and the user may input the correction prompt CP on the operation interface 110. The correction prompt CP is, for example, a suggestion for how the communication result CS may be improved. Therefore, the AI communication tool 121 receives the correction prompt CP corresponding to the communication result CS in step S204. In step S205, the prompt analysis model 122 generates the answers ANS1~ANSn according to the correction prompt CP and generates the similarities SML1~SMLn between the correction prompt CP and the answers ANS1~ANSn. In step S206, the prompt analysis model 122 selects the optimized answer ANS from the answers ANS1~ANSn according to the extent of the similarities SML1~SMLn. Furthermore, the prompt analysis model 122 corrects the communication result CS according to the optimized answer ANS to generate the corrected communication result CS' in step S206.

In step S207, the AI communication tool 121 receives feedback from the user and classifies the corrected communication result CS' according to the user's feedback.

When the feedback is positive, it means that the user is satisfied with the corrected communication result CS' generated by the AI communication tool 121. That is to say, the corrected communication result CS' generated by the AI communication tool 121 is accurate. Therefore, in step S208, the AI communication tool 121 classifies the corrected communication result CS' as a first classification according to the user's positive feedback. Next, the AI communication tool 121 submits the corrected communication result CS' classified as the first classification to the database 130 in step S212. Then, the AI communication tool may return to step S207 to continue receiving other feedback.

On the other hand, in step S209, when the feedback is negative, it means that the user is not satisfied with the corrected communication result CS', and the AI communication tool 121 determines whether the user chooses to edit the corrected communication result CS' according to the user's negative feedback.

When the user is not satisfied with the content of the corrected communication result CS' and does not want to edit the corrected communication result CS' through the operation interface 110, the AI communication tool 121 classifies the corrected communication result CS' as a second classification according to the user's negative feedback in step S210. Next, the AI communication tool 121 submits the corrected communication result CS' to the database 130 in step S212.

When the user is not satisfied with the content of the corrected communication result CS' and wants to edit the corrected communication result CS' through the operation interface 110, the user may edit the corrected communication result CS' on the operation interface 110 to generate the edited corrected communication result CS1''. Therefore, in step S211, the AI communication tool 121 receives the edited corrected communication result CS1''. In step S213, the AI communication tool 121 submits the edited corrected communication result CS1'' to the database 130. For example, the user may edit all the content of the corrected communication result CS', or only correct part of the content of the corrected communication result CS'. The user clicks the submit button on the operation interface 110, thereby submitting the edited corrected communication result CS1'' to the database 130. Then, the AI communication tool may return to step S207 to continue receiving other feedback.

In some embodiments, the edited corrected communication result CS1'' may also be submitted to the prompt analysis model 122 in step S213.

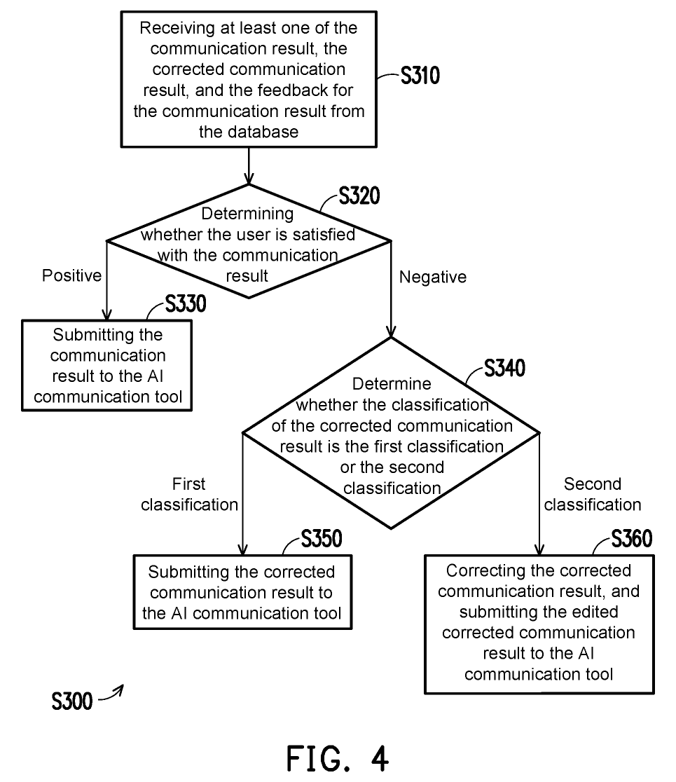

Please refer to FIG. 1, FIG. 3A, FIG. 3B, and FIG. 4. FIG. 4 illustrates a flowchart of a training method according to an embodiment of the present disclosure. In this embodiment, a training method S300 is applicable to a training model TS. The training method S300 includes steps S310~S360. In step S310, at least one of the communication result CS, the corrected communication result CS', and the feedback (such as positive feedback, negative feedback) for the communication result CS is received from the database 130. In the embodiment of the present disclosure, the database 130 may transmit at least one of the communication result CS, the corrected communication result CS', and the feedback for the communication result CS to the training model TS by an electrical connection or a wireless communication method.

In step S320, the training model TS determines whether the user is satisfied with the communication result CS. Furthermore, the training model TS determines whether the user is satisfied with the communication result CS according to the feedback for the communication result CS.

When the training model TS determines that the feedback for the communication result CS is positive, the training model TS may submit the communication result CS to the AI communication tool 121 in step S330.

In step S320, when the training model TS determines that the feedback for the communication result CS is negative, the training model TS may determine in step S340 whether the classification of the corrected communication result CS' is the first classification or the second classification, thereby further determining whether the user is satisfied with the corrected communication result CS'.

In step S340, when the training model TS determines that the corrected communication result CS' is the first classification, it means that the user is satisfied with the corrected communication result CS'. Therefore, the training model TS may submit the corrected communication result CS' classified as the first classification to the AI communication tool 121 in step S350.

In step S340, when the training model TS determines that the corrected communication result CS' is classified as the second classification, it means that the user is not satisfied with the corrected communication result CS'. Therefore, the training model TS may correct or edit the corrected communication result CS' in the second classification in step S360, thereby generating an edited corrected communication result CS2'', and submit the edited corrected communication result CS2'' to the AI communication tool 121. The AI communication tool 121 submits the edited corrected communication result CS2'' to the database 130. In this embodiment, both the corrected communication result CS' and the edited corrected communication result CS2'' may serve as training samples for the training model TS.

In some embodiments, the training model TS receives the communication result CS and the corrected communication result CS' together from the database 130 and executes steps S320 and S340 simultaneously. In some embodiments, the training model TS may execute only step S340 according to the corrected communication result CS' received from the database 130.

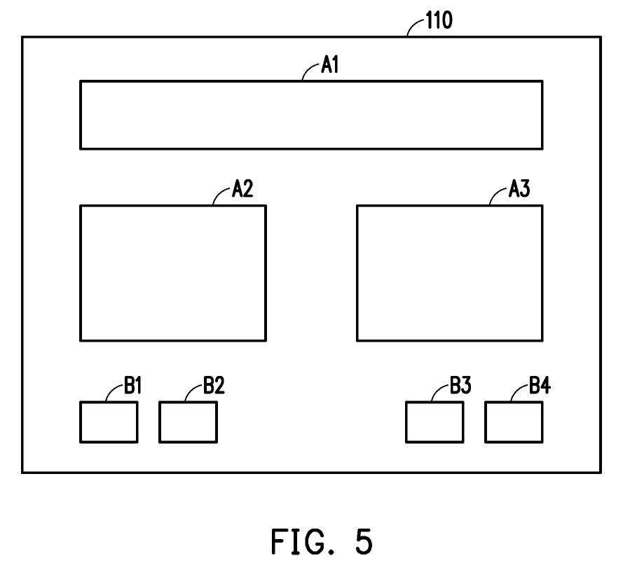

Please refer to FIG. 1 and FIG. 5. FIG. 5 illustrates a schematic view of an operation interface according to an embodiment of the present disclosure. In this embodiment, the operation interface 110 includes regions A1~A3 and buttons B1~B4. The operation interface 110 may display the communication result CS in the region A2. If the user is satisfied with the communication result CS displayed in the region A2, the user may click the button B4 to submit the communication result CS currently displayed on the region A2 to the database 130. Then, the user may click the button B3 to terminate the editing of the communication result CS.

If the user is not satisfied with the communication result CS displayed in the region A2, the user may input the correction prompt CP in the region A1 of the operation interface 110. Next, the user may click the button B4 to submit the correction prompt CP displayed in the region A1 to the prompt analysis model 122. The prompt analysis model 122 generates the answers ANS1~ANSn according to the input correction prompt CP and selects the optimized answer ANS according to the similarities SML1~SMLn between the correction prompt CP and the answers ANS1~ANSn, and corrects the communication result CS according to the optimized answer ANS to generate the corrected communication result CS'. The operation interface 110 displays the corrected communication result CS' in the region A3.

In this embodiment, when the user is satisfied with the corrected communication result CS' displayed in the region A3, the user may click the button B1 to mark the corrected communication result CS' currently displayed in the region A3 as a satisfactory answer (i.e., provide positive feedback). Then, the user may click the button B4 again to submit the corrected communication result CS' displayed in the region A3 to the database 130.

In this embodiment, if the user is not satisfied with the corrected communication result CS' displayed in the region A3, the user may click the button B2 to mark the corrected communication result CS' currently displayed in the region A3 as an unsatisfactory answer (i.e., provide negative feedback). In addition, the user may also edit the corrected communication result CS' displayed in the region A3, and click the button B4 again to submit the edited corrected communication result CS1'' to the database 130.

Alternatively, when the user has no intention to manually edit the corrected communication result CS', the user may click the button B3 to terminate the editing of the corrected communication result CS'.

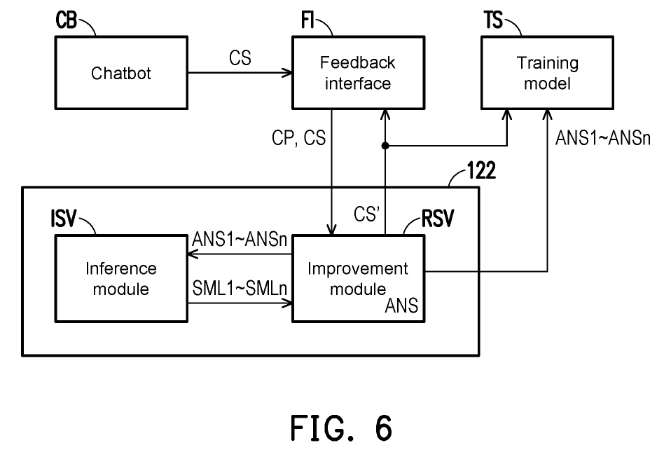

Please refer to FIG. 1 and FIG. 6. FIG. 6 illustrates a block diagram according to an embodiment of the present disclosure. The operation of FIG. 6 is applicable to a system. The system includes a chatbot CB, a feedback interface FI, a prompt analysis model 122, and a training model TS. The chatbot CB may include the AI communication tool 121 as shown in FIG. 1 for implementation. The feedback interface FI may include the operation interface 110 as shown in FIG. 1. The prompt analysis model 122 includes an improvement module RSV and an inference module ISV. The chatbot CB may output the corresponding communication result CS according to the data and question provided by the user. When the user is not satisfied with the communication result CS generated by the chatbot CB, the feedback interface FI submits the communication result CS and the correction prompt CP to the improvement module RSV.

The improvement module RSV generates the answers ANS1~ANSn according to the correction prompt CP and submits the answers ANS1~ANSn to the inference module ISV.

The inference module ISV compares the content of the answers ANS1~ANSn with that of the correction prompt CP to generate the similarities SML1~SMLn corresponding to the answers ANS1~ANSn. The inference module ISV provides the similarities SML1~SMLn to the improvement module RSV.

The improvement module RSV selects the optimized answer ANS from the answers ANS1~ANSn according to the similarities SML1~SMLn and corrects the communication result CS according to the optimized answer ANS to generate the corrected communication result CS'. The improvement module RSV submits the corrected communication result CS' to the feedback interface FI. Therefore, the user is able to read the corrected communication result CS' through the feedback interface FI.

In this embodiment, the improvement module RSV may submit the corrected communication result CS' and the answers ANS1~ANSn to the training model TS. The training model TS may use the corrected communication result CS' and the answers ANS1~ANSn as training samples. In some embodiments, the improvement module RSV may submit the corrected communication result CS' and the answers ANS1~ANSn to the training model TS through the feedback interface FI.

In this embodiment, the chatbot CB and the feedback interface FI may be disposed in a cloud device or an electronic device, respectively. The prompt analysis model 122 and the training model TS may be disposed in the same or different equipment (e.g., servers).

In this embodiment, the improvement module RSV and the inference module ISV are implemented by, for example, computing circuits or processors of any form.

In summary, the prompt analysis model of the present disclosure automatically generates at least one answer according to the correction prompt and uses the at least one answer as response samples to train the AI communication tool. In this way, the user does not need to spend so much time to provide multiple response samples. The training method is able to obtain a large amount of response samples. In addition, the prompt analysis model selects an optimized answer from the at least one answer and corrects the communication result according to the optimized answer to generate a corrected communication result. The training method may also generate a corrected communication result that is the closest to the correction prompt.

Although the present disclosure has been disclosed above with embodiments, they are not intended to limit the present disclosure. Any person having ordinary knowledge in the technical field may make minor modifications and refinements without departing from the spirit and scope of the present disclosure. Therefore, the scope to be protected by the present disclosure shall be defined by the appended claims.

What is claimed is:

1. A training method for an artificial intelligence (AI) communication tool, wherein the AI communication tool is installed in a computer system, and the computer system comprises a processor configured to execute the training method, the training method comprises:
by the AI communication tool, providing a communication result and receiving a correction prompt corresponding to the communication result;
by a prompt analysis model, generating at least one answer based on the correction prompt and generating at least one similarity between the correction prompt and the at least one answer based on the at least one answer; and
by the prompt analysis model, selecting an optimized answer from the at least one answer based on the at least one similarity, correcting the communication result based on the optimized answer to generate a corrected communication result, and providing the corrected communication result to the AI communication tool.

2. The training method according to claim 1, wherein the step of selecting the optimized answer from the at least one answer based on the at least one similarity comprises:
assigning at least one score to the at least one answer according to the at least one similarity; and
selecting an answer corresponding to a highest score as the optimized answer.

3. The training method according to claim 2, wherein the higher the at least one similarity is, the higher the at least one score is.

4. The training method according to claim 1, wherein the step of generating the at least one similarity between the correction prompt and the at least one answer based on the at least one answer comprises:
retrieving at least one first message from a first answer among the at least one answer;
retrieving at least one second message from the correction prompt; and
generating a similarity corresponding to the first answer according to at least one of a text similarity, a factual relationship, and a contradictory relationship between the at least one first message and the at least one second message.

5. The training method according to claim 1, further comprising:
providing the corrected communication result to a training model; and
by the training model, training the AI communication tool according to a classification of the corrected communication result.

6. The training method according to claim 5, further comprising:
by the AI communication tool, classifying the corrected communication result as a first classification according to a positive feedback; and
by the AI communication tool, classifying the corrected communication result as a second classification according to a negative feedback.

7. The training method according to claim 6, wherein the step of training the AI communication tool according to the classification of the corrected communication result comprises:
providing the corrected communication result classified as the first classification to the AI communication tool.

8. The training method according to claim 6, wherein the step of training the AI communication tool according to the classification of the corrected communication result comprises:
correcting the corrected communication result classified as the second classification by the training model.

9. The training method according to claim 5, further comprising:
determining the classification of the corrected communication result according to an operation command from an operation interface.

10. An electronic device, comprising:
an operation interface; and
a processor, coupled to the operation interface, wherein the processor comprises:
an artificial intelligence (AI) communication tool, configured to provide a communication result and receive a correction prompt corresponding to the communication result; and
a prompt analysis model, configured to generate at least one answer based on the correction prompt, generate at least one similarity between the correction prompt and the at least one answer based on the at least one answer, select an optimized answer from the at least one answer based on the at least one similarity, correct the communication result based on the optimized answer to generate a corrected communication result, and provide the corrected communication result to the AI communication tool.

11. The electronic device according to claim 10, wherein the prompt analysis model assigns at least one score to the at least one answer according to the at least one similarity and selects an answer corresponding to a highest score as the optimized answer.

12. The electronic device according to claim 10, wherein the higher the at least one similarity is, the higher the at least one score is.

13. The electronic device according to claim 10, wherein the prompt analysis model retrieves at least one first message from a first answer among the at least one answer, retrieves at least one second message from the correction prompt, and generates a similarity corresponding to the first answer according to at least one of a text similarity, a factual relationship, and a contradictory relationship between the at least one first message and the at least one second message.

14. The electronic device according to claim 10, wherein
the prompt analysis model provides the corrected communication result to a training model; and
the training model trains the AI communication tool according to a classification of the corrected communication result.

15. The electronic device according to claim 14, wherein the AI communication tool classifies the corrected communication result as a first classification according to a positive feedback and classifies the corrected communication result as a second classification according to a negative feedback.

16. The electronic device according to claim 15, wherein the training model provides the corrected communication result classified as the first classification to the AI communication tool.

17. The electronic device according to claim 15, wherein the training model corrects the corrected communication result classified as the second classification.

18. The electronic device according to claim 14, wherein the training model determines the classification of the corrected communication result according to an operation command from the operation interface.
